(19) United States
(12) Patent Application Publication
(10) Pub. No.: US 2024/0155430 A1
(43) Pub. Date: May 9, 2024

(54) METHOD AND APPARATUS FOR EGESTING UPLINK STREAMING FROM 5G NETWORKS

(71) Applicant: Tencent America LLC, Palo Alto, CA (US)

(72) Inventor: Iraj SODAGAR, Los Angeles, CA (US)

(73) Assignee: Tencent America LLC, Palo Alto, CA (US)

(21) Appl. No.: 18/497,556

(22) Filed: Oct. 30, 2023

Related U.S. Application Data
(60) Provisional application No. 63/423,724, filed on Nov. 8, 2022.

(51) Int. Cl. H04W 28/08; H04W 48/14; H04W 48/16

(52) U.S. Cl. CPC H04W 28/0858; H04W 48/14; H04W 48/16

(57) ABSTRACT

A method performed by at least one processor in a 5G media streaming uplink (5GMSu) application provider, comprises: establishing a 5GMSu session with a 5GMSu application function (AF) on the 5GMSu application provider; creating a content publishing configuration associated with an uplink media content with the 5GMSu AF, wherein the 5GMSu AF provisions a 5GMSu application service (AS) for the content publishing configuration; receiving, from the 5GMSu AF, confirmation that the 5GMSu AS is configured based on the content publishing configuration, the confirmation including an 5GMSu service access information entry; publishing, to a 5GMSu aware application, the 5GMSu service access information entry; and obtaining, from the 5GMSu AS, the uplink media content.

### CROSS-REFERENCE TO RELATED APPLICATION

This application claims priority from U.S. Provisional Application No. 63/423,724, filed on Nov. 8, 2022, in the United States Patent and Trademark Office, the disclosure of which is incorporated herein by reference in its entirety.

### FIELD

The disclosure generally relates to 5th generation (5G) media streaming (5GMS), and, in particular, to a method and apparatus for egesting uplink streaming from 5G networks.

### BACKGROUND

The 3rd Generation Partnership Project (3GPP) TS26.512 defines the concept of uplink streaming where the content is streamed from a device to an external service provider. However, the existing streaming architecture does not provide or define how to egest by external parties content from uplink streams.

### SUMMARY

According to one or more embodiments, a method performed by at least one processor in a 5G media streaming uplink (5GMSu) application provider, comprises: establishing a 5GMSu session with a 5GMSu application function (AF) on the 5GMSu application provider; creating a content publishing configuration associated with an uplink media content with the 5GMSu AF, wherein the 5GMSu AF provisions a 5GMSu application service (AS) for the content publishing configuration; receiving, from the 5GMSu AF, confirmation that the 5GMSu AS is configured based on the content publishing configuration, the confirmation including an 5GMSu service access information entry; publishing, to a 5GMSu aware application, the 5GMSu service access information entry; and obtaining, from the 5GMSu AS, the uplink media content.

According to one or more embodiments, a method performed by at least one processor in a 5G media streaming uplink (5GMSu) application function (AF), comprises: establishing a 5GMSu session on the 5GMSu application provider; creating a content publishing configuration associated with an uplink media content with the 5GMSu application provider; provisioning a 5GMSu application server (AS) for the content publishing configuration; receiving, from the 5GMSu AS, confirmation that the configuration of the 5GMSu AS based on the content publishing configuration is successful; and transmitting, to the 5GMSu application provider, confirmation that the 5GMSu AS is configured based on the content publishing configuration, the confirmation including 5GMSu service access information entry that the 5GMSu application provider publishes to a user equipment (UE).

According to one or more embodiments, a 5G media streaming uplink (5GMSu) application provider server, comprising: at least one memory configured to store program code; and at least one processor configured to read the program code and operate as instructed by the program code, the program code including: establishing code configured to cause the at least one processor to establish a 5GMSu session with a 5GMSu application function (AF) on the 5GMSu application provider; creating code configured to cause the at least one processor to create a content publishing configuration with the 5GMSu AF, wherein the 5GMSu AF provisions a 5GMSu application service (AS) for the content publishing configuration; receiving code configured to cause the at least one processor to receive, from the 5GMSu AF, confirmation that a 5GMSu Application Server (AS) is configured based on the content publishing configuration, the confirmation including an 5GMSu service access information entry, publishing code configured to cause the at least one processor to publish, to a 5GMSu aware application, the 5GMSu service access information entry, and obtaining code configured to cause the at least one processor to obtain, from the 5GMSu AS, the uplink media content.

According to one or more embodiments, a 5G media streaming uplink (5GMSu) system executing an application function (AF), comprises: at least one memory configured to store program code; and at least one processor configured to read the program code and operate as instructed by the program code, the program code including establishing code configured to cause the at least one processor to establish a 5GMSu session on the 5GMSu application provider; creating code configured to cause the at least one processor to create a content publishing configuration associated with an uplink media content with the 5GMSu application provider, provisioning code configured to cause the at least one processor to provision a 5GMSu application server (AS) for the content publishing configuration, receiving code configured to cause the at least one processor to receive, from the 5GMSu AS, confirmation that the configuration of the 5GMSu AS based on the content publishing configuration is successful, and transmitting code configured to cause the at least one processor to transmit, to the 5GMSu application provider, confirmation that the 5GMSu AS is configured based on the content publishing configuration, the confirmation including 5GMSu service access information entry that the 5GMSu application provider publishes to a user equipment (UE).

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is a diagram of a media architecture for media uplink streaming, according to embodiments.

FIG. 4 is a diagram of an operation flow for egesting media in an uplink stream, according to embodiments.

FIG. 5 is a flowchart of an example process performed by a 5GMSu application provider, according to embodiments.

FIG. 6 is a flowchart of an example process performed by a 5GMSu application function, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

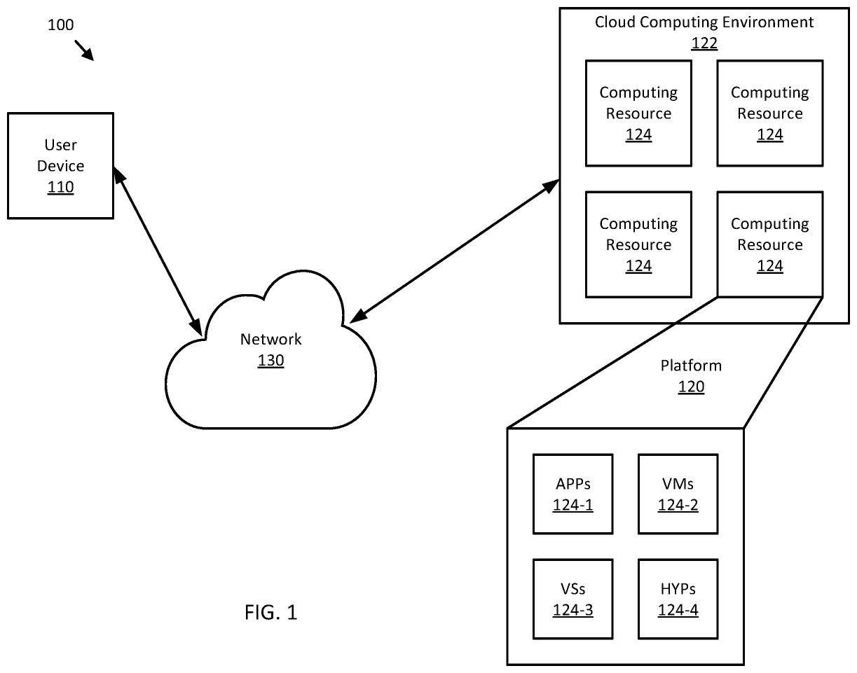

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

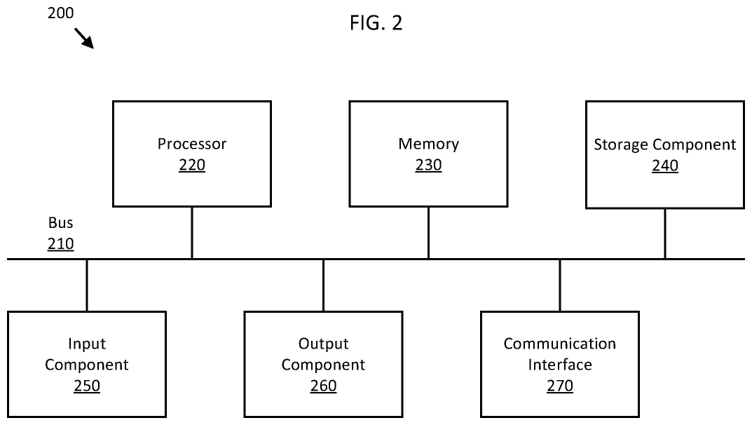

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

A 5G media streaming (5GMS) system may be an assembly of application functions, application servers, and interfaces from the 5G media streaming architecture that support either downlink media streaming services or uplink media streaming services, or both. A 5GMS Application Provider may include a party that interacts with functions of the 5GMS system and supplies a 5GMS Aware Application that interacts with functions of the 5GMS system. The 5GMS Aware Application may refer to an application in the user equipment (UE), provided by the 5GMS Application Provider, that contains the service logic of the 5GMS application service, and interacts with other 5GMS Client and Network functions via the interfaces and application programming interfaces (APIs) defined in the 5GMS architecture. A 5GMS Client may refer to a UE function that is either a 5GMS downlink (5GMSd) Client or a 5GMS uplink (5GMSu) Client, or both.

The 5GMSd Client may refer to a UE function that includes at least a 5G media streaming player and a media session handler for downlink streaming and that may be accessed through well-defined interfaces/APIs. The 5GMSu Client may refer to an originator of a 5GMSu service that may be accessed through well-defined interfaces/APIs. A 5GMSu media streamer may refer to a UE function that enables uplink delivery of streaming media content to an Application Server (AS) function of the 5GMS Application Provider, and which interacts with both the 5GMSu Aware Application for media capture and subsequent streaming, and the Media Session Handler for media session control.

A dynamic policy may refer to a dynamic policy and charging control (PCC) rule for an uplink or downlink application flow during a media session. An egest session may refer to an uplink media streaming session from the 5GMS AS towards the 5GMSu Application Provider. An ingest session may refer to a session to upload the media content to a 5GMSd AS. A policy template may refer to a collection of (semi-static) Policy or Control Function (PCF)/Network Exposure Function (NEF) API parameters which are specific to the 5GMS Application Provider and also the resulting PCC rule. A policy template ID may identify the desired policy template, which is used by the 5GMSd Application Function (AF) to select the appropriate PCF/NEF API towards the 5G system so that the PCF can compile the desired PCC rule. The Media Player Entry may refer to a document or a pointer to a document that defines a media presentation (e.g., a media presentation description (MPD) for DASH or a uniform resource locator (URL) to a video clip file). A Media Streamer Entry may refer to a pointer (e.g., in the form of a URL) that defines an entry point of an uplink media streaming session. A presentation entry may refer to a document or a pointer to a document that defines an application presentation, such as an HTML5 document.

A Provisioning Session may refer to a data structure supplied at an interface (Mid) by a 5GMSd Application provider that configures the 5GMSd features relevant to a set of 5GMSd Aware Applications. A 5GMSd Media Player may refer to a UE function that enables playback and rendering of a media presentation based on a media play entry and exposing some basic controls such as play, pause, seek, stop, to the 5GMSd Aware Application. Server Access Information may refer to a set of parameters and addresses (including 5GMSd AF and 5GMSd AS addresses) which are needed to activate the reception of a streaming session. A Service and Content Discovery may refer to functionality and procedures provided by a 5GMSd Application Provider to a 5GMS Aware Application that enables the end user to discover the available streaming service and content offerings and select a specific service or content item for access. A Service Announcement may refer to procedures conducted between the 5GMS Aware Application and the 5GMS Application Provider such that the 5GMS Aware Application is able to obtain 5GMS Service Access Information, either directly or in the form of a reference to that information.

A third party player may refer to a part of an application that uses APIs to exercise selected 5GMSd functions to play back media content. A third party uplink streamer may refer to a part of an application that uses APIs to exercise selected 5GMSu functions to capture and stream media content.

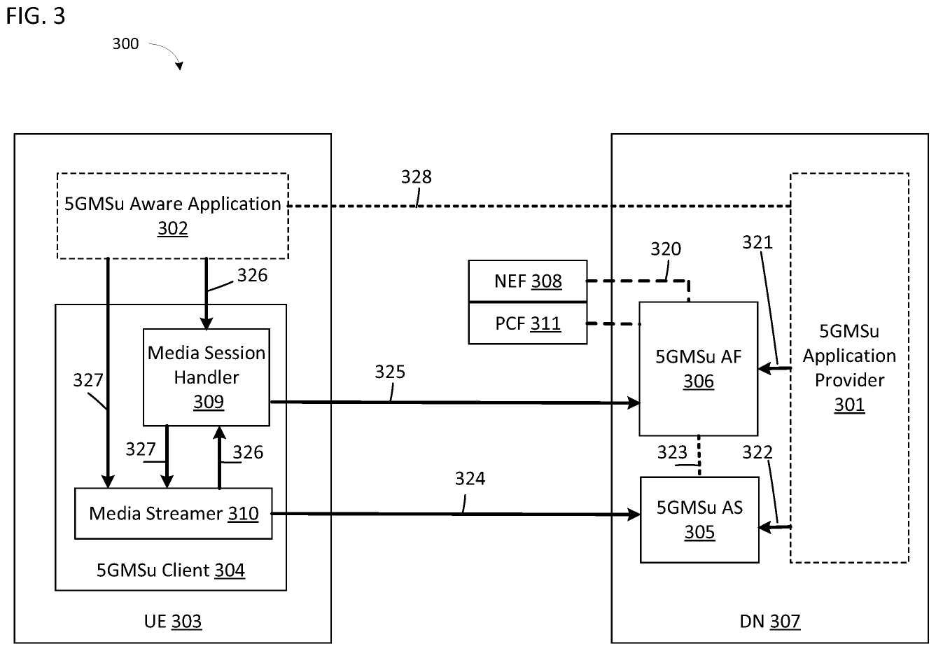

FIG. 3 is a diagram of a media architecture 300 for media uplink streaming according to embodiments. A 5GMSu Application Provider 301 may use 5GMSu for uplink streaming services. In one or more examples, an uplink stream service may be a live video streaming session using a social medial platform. The 5GMSu Application Provider 301 may be implemented as a server. The 5GMSu Application Provider 301 may provide a 5GMSu Aware Application 302 on a UE 303 to make use of 5GMSu Client 304 and network functions using interfaces and APIs defined in 5GMSu. A 5GMSu application server (AS) 305 may be an AS dedicated to 5G Media Uplink Streaming. The 5GMSu Client 304 may be an internal function of the UE 303 dedicated to 5G Media Uplink Streaming.

A 5GMSu application function (AF) 306 and the 5GMSu AS 305 may be Data Network (DN) 307 functions. In one or more examples, the 5GMSu AF 306 may be implemented as a server. In one or more examples, the 5GMSu AF 306 may be a software module or program executed by the 5GMS system. Functions in trusted DNs may be trusted by the operator's network. Therefore, AFs in trusted DNs may directly communicate with some or all 5G Core functions. Functions in external DNs may only communicate with 5G Core functions via a network exposure function (NEF) 308 using link 320. The NEF 308 facilitates secure access to exposed network services and capabilities of the 5G network.

The media architecture 300 may connect UE 303 internal functions and related network functions for 5G Media Uplink Streaming. Accordingly, the media architecture 300 may include a number of functions. For example, the 5GMSu Client 304 on UE 303 may be an originator of a 5GMSu service that may be accessed through interfaces/APIs. The 5GMSu Client 304 may include two sub-functions, a Media Session Handler 309 and a Media Streamer 310. The Media Session Handler 309 may communicate with the 5GMSu AF 306 in order to establish, control and support the delivery of a media session. The Media Session Handler 309 may expose APIs that may be used by the 5GMSu Aware Application 302. The Media Streamer 310 may communicate with 5GMSu AS 305 to stream the media content and provide a service to the 5GMSu Aware Application 302 for media capturing and streaming, and the Media Session Handler 309 for media session control. The 5GMSu Aware Application 302 may control the 5GMSu Client 304 by implementing external application or content service provider specific logic and enabling the establishment of a media session. The 5GMSu AS 305 may host 5G media functions and may be implemented as a content delivery network (CDN), for example. The 5GMSu Application Provider 301 may be an external application or content specific media functionality (e.g., media storage, consumption, transcoding and redistribution) that uses 5GMSu to stream media from the 5GMSu Aware Application 302. The 5GMSu AF 306 may provide various control functions to the Media Session Handler 309 on the UE 303 and/or to the 5GMSu Application Provider 301. The 5GMSu AF 306 may relay or initiate a request for a different policy control function (PCF) 311 treatment or interact with other network functions.

The media architecture 300 may include a number of different interfaces. For example, link 321 may relate to M1u, which may be a 5GMSu Provisioning API exposed by 5GMSu AF 306 to provision usage of media architecture 300 and to obtain feedback. Link 322 may relate to M2u, which may be a 5GMSu Publish API exposed by 5GMSu AS 305 and used when the 5GMSu AS 305 in a trusted DN, such as DN 307, is selected to receive content for streaming service. Link 323 may relate to M3u, which may be an internal API used to exchange information for content hosting on 5GMSu AS 305 within a trusted DN such as DN 307. Link 324 may relate to M4u, which may be a Media Uplink Streaming API exposed by the 5GMSu AS 305 to the Media Streamer 310 to stream media content. Link 325 may relate to M5u, which may be a Media Session Handling API exposed by 5GMSu AF 305 to Media Session Handler for media session handling, control, and assistance that also include appropriate security mechanisms (e.g., authorization and authentication). Link 326 may relate to M6u, which may be a UE 303 Media Session Handling API exposed by Media Session Handler 309 to 5GMSu Aware Application 302 to make use of 5GMSu functions. Link 327 may relate to M7u, which may be a UE Media Streamer API exposed by Media Streamer 310 to the 5GMSu Aware Application 302 and the Media Session Handler 309 to make use of the Media Streamer 310. Link 328 may relate to M8u, which may be an Application API which is used for information exchange between 5GMSu Aware Application 302 and 5GMSu Application Provider 301, for example to provide service access information to the 5GMSu Aware Application 302. The UE 303 may also be implemented in a self-contained manner such that interfaces M6u 326 and M7u 327 are not exposed.

The current 5G media streaming architecture only defines a general architecture for uplink and downlink media streaming, where the 5G media-streaming architecture for uplink streaming is illustrated in FIG. 3. While a general uplink process is defined, this general process does not include a procedure for egesting, by an external party, content of an uplink stream from the 5G network.

Embodiments of the present disclosure are directed to defining an uplink egest process. In one or more examples, the uplink egest process is based on a downlink streaming ingest process.

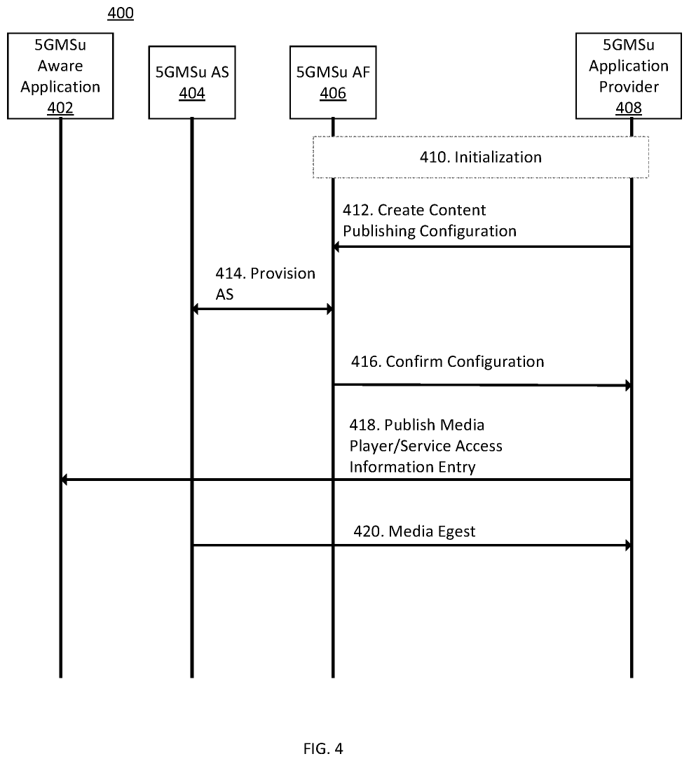

FIG. 4 is a diagram of an operation flow 400 for provisioning a 5GMS system for uplink streaming, according to embodiments. The operation flow may be performed between a 5GMSu Aware Application 402, a 5GMSu AS 404, a 5GMSu AF 406, and a 5GMSu Application Provider 408. The 5GMSu Aware Application 402 may correspond to the 5GMSu Aware Application 302 (FIG. 3). The 5GMSu AS 404 may correspond to the 5GMSu AS 305 (FIG. 3). The 5GMSu AF 406 may correspond to the 5GMSu AF 306 (FIG. 3). The 5GMSu Application Provider 408 may correspond to the 5GMSu Application provider 301 (FIG. 3).

In operation 410, an initialization procedure may be performed between the 5GMSu Application Provider 408 and the 5GMSu AF 406. During this operation, the 5GMSu Application Provider 408 discovers an entry point and authenticates itself with the 5GMSu AF 406.

In operation 412, a content publishing configuration is created between the 5GMSu Application Provider 408 and the 5GMSu AF 406. For example, the 5GMSu Application Provider 408 creates a new Content Publishing Configuration through the 5GMSu AF 406. The configuration specifies one or more of a path, protocol, entry point, an egest push/pull mode, and a content preparation feature. Upon successful configuration, the 5GMSu AF 406 responds with a Content Publishing Configuration identifier, and the location of the 5GMSu AS 404 from which to pull the content if using the pull mode. In one or more examples, the 5GMSu Application Provider 408 transmits a message to the 5GMSu AF 406 specifying one or more content publishing configurations including the path, protocol, entry point, an egest push/pull mode, and the content preparation feature.

In one or more examples, the content preparation feature enables the 5GMS Application Provider 408 to specify content manipulation by network-side components of the 5GMS System according to provisioned Content Preparation Templates. When the 5GMSu Application Provider 408 has provisioned the content preparation feature for uplink media streaming, network-side components of the 5GMS System may manipulate the media content ingested from the 5GMSu Client in the UE, and may cache the manipulated content prior to egesting it to the 5GMSu Application Provider 408.

In operation 414, the 5GMSu AS 404 is provisioned by the 5GMSu AF 406. For example, the 5GMSu AF 406 configures the related 5GMSu AS 404 for a particular Content Publishing Configuration. This operation may involve instructing the 5GMSu AS 404 to set one or more content preparation processes. The 5GMSu AS 406 responds indicating whether the configuration is successful or not. In one or more examples, the particular Content Publishing Configuration is based on the Content Publishing Configuration specified in operation 412.

In operation 416, the 5GMSu AF 406 confirms the configuration. For example, the 5GMSu AF 406 communicates the Content Publishing Configuration of the 5GMSu AS 404 back to the 5GMSu Application Provider 408 for further media push or pull. In one or more examples, the 5GMSu AF 406 transmits a message to the 5GMSu Application Provider 408 that confirms the configuration of the 5GMSu AS 404 and includes an uplink entry point or address (e.g., URL) of the 5GMSu AS 404.

In operation 418, the uplink entry point is published. For example, the 5GMSu Application Provider 408 publishes the uplink entry point for the 5GMSu AS 404 to the 5GMSd-Aware Application 402 to enable access to the content or make the content available as part of the Service Access Information through the M5u interface. In one or more examples, the 5GMSu Application Provider 408 transmits a message to the 5GMSu Aware Application 402 with the uplink entry point of the 5GMSu AS 404. The Service Access Information may be a set of parameters and addresses that are needed by a 5GMS Client (e.g., UD 303 in FIG. 3) to activate transmission on an uplink media streaming session, perform dynamic policy invocation, consumption reporting and/or metrics reporting, and request AF-based network assistance.

In operation 420, media egest is performed. For example, the 5GMSu Application Provider 408 may start pulling (e.g., egest pull mode specified in content publishing configuration) or receiving content (e.g., egest push mode specified in content publishing configuration) from the 5GMSu AS 406. In one or more examples, the 5GMSu AS 406 performs the requested content preparation before making the uplink content ready for being pulled by or pushed to the 5GMSu Application Provider. In one or more examples, the 5GMSu AS 406 receives content from the Media Streamer 310 of the UE 303 (FIG. 3). In one or more examples, the pull of media content from the 5GMSu AS 404 may be triggered by a request from the 5MGSu Client through M8u.

In one or more examples, a 5GMSu Application Provider may update a Content Publishing Configuration subsequently to modify some one or more parameters. The subset of parameters that may be updated may be limited by the 5GMSu AF.

According to embodiments, a method for egesting an uplink media stream from a device to a 5G network by an external party is provided. After provisioning the session, the information of the uplink entry point is sent to a 5G device using service access information or through the 5G network interface for this purpose, and then devices start streaming to the 5G Application Server using the provided uplink entry point. Subsequently, the 5G network after content preparation, either makes the content available for being pulled or pushes the content for a defined destination. In either case, the pull/push protocol may be defined previously as part of provisioning.

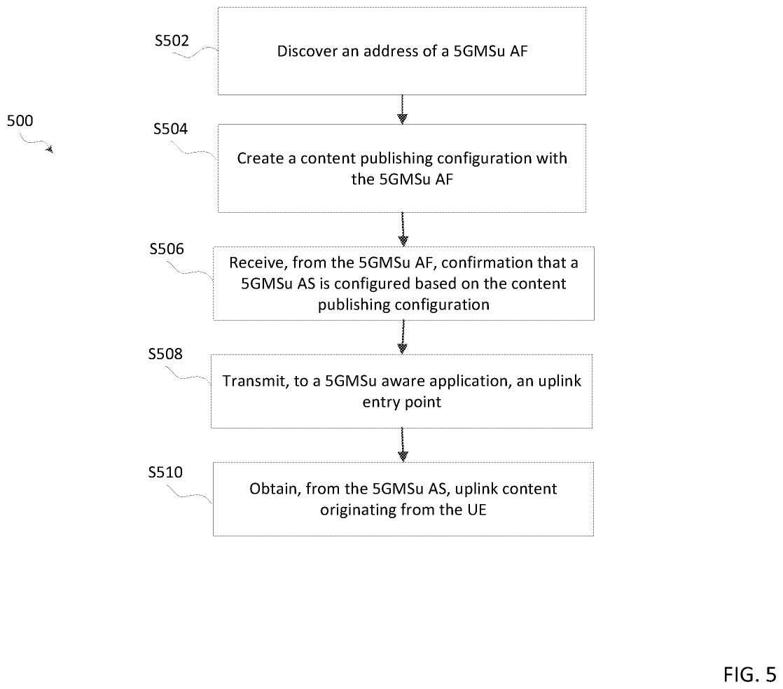

FIG. 5 is a flowchart of an example process 500 performed by a 5GMSu application provider, according to embodiments. The process 500 may be performed by the 5GMSu Application Provider 301 (FIG. 3) or the 5GMSu Application Provider 408 (FIG. 4).

The process may start at operation S502 where an address of the 5GMSu AF is discovered. For example, the address of the 5GMSu AF 406 may be discovered by the 5GMSu Application Provider 408 during the initialization process according to operation 410 (FIG. 4).

The process proceeds to operation S504 where a content publishing configuration is created with a 5GMSu AF. For example, the 5GMSu Application Provider 408 creates a content publishing configuration with the 5GMSu AF 406 in accordance with operation 412 (FIG. 4).

The process proceeds to operation S506, where a confirmation that a 5GMSu AS is configured based on the content publishing configuration is received from the 5GMSu AF. For example, the 5GMSu Application provider 408 receives conformation from the 5GMSu AF 406 that the 5GMSu AS 404 is configured based on the content publishing configuration in accordance with operation 416. The confirmation from the 5GMSu AF 406 may include an uplink entry point of the 5GMSu AS 404.

The process proceeds to operation S508 where an uplink entry point is transmitted to a 5GMSu aware application. For example, the 5GMSu Application Provider 408 may transmit a message including the uplink entry point of the 5GMSu AS 404 to the 5GMSu aware application 402 in accordance with operation 418 (FIG. 4).

The process proceeds to operation S510 where uplink content originating from UE is obtained. For example, after receiving the uplink entry point of the 5GMSu AS 404, the UE may start uploading content to the 5GMSu AS 404. If an egest pull mode is specified in the content publishing configuration, the 5GMSu Application Provider 408 may retrieve the content from the 5GMSu AS 404. If an egest push mode is specified in the content publishing configuration, the 5GMSu AS 404 may transmit the content to the 5GMSu Application Provider 408.

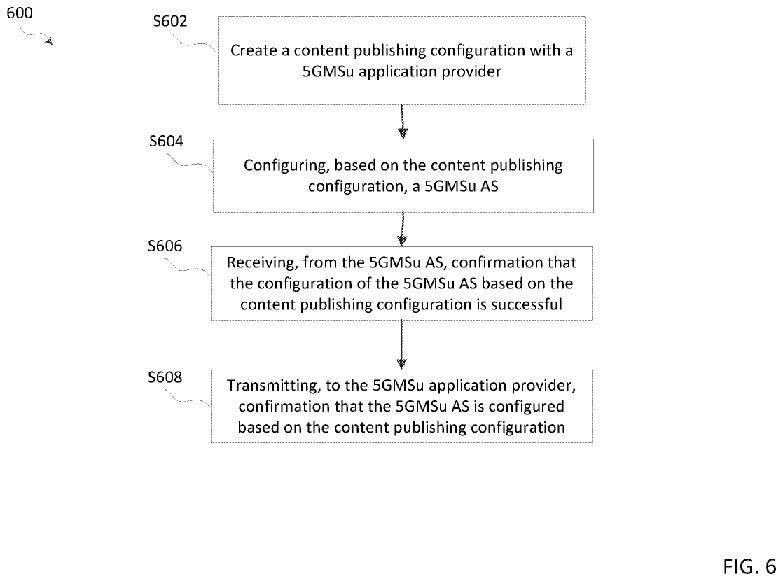

FIG. 6 is a flowchart of an example process 600 performed by a 5GMSu application function, according to embodiments. The process 600 may be performed by the 5GMSu AF 306 (FIG. 3) or the 5GMSu AF 406 (FIG. 4).

The process may start at operation S602, where a content publishing configuration is created with a 5GMSu AF. For example, the 5GMSu Application Provider 408 creates a content publishing configuration with the 5GMSu AF 406 in accordance with operation 412 (FIG. 4).

The process proceeds to operation S604, where a 5GMSu AS is configured based on the content publishing configuration. For example, the 5GMSu AF 406 configures the 5GMSu AS 404 in accordance with operation 414 (FIG. 4).

The process proceeds to operation S606, where confirmation of whether the configuration of the 5GMSu AS is successful. For example, after provisioning the 5GMSu AS 404 with the content publishing configuration, the 5GMSu AF 406 receives confirmation from the 5GMSu AS 404 whether the configuration of the 5GMSu AS 404 based on the content publishing configuration is successful.

The process proceeds to operation S608, where a confirmation that the 5GMSu AS is configured based on the content publishing configuration is transmitted to the 5GMSu Application Provider. For example, the 5GMSu AF 406 transmits a confirmation to the 5GMSu Application Provider 408 in accordance with operation 416 (FIG. 4) indicating that the 5GMSu AS 404 is configured based on the content publishing configuration.

Further, the proposed methods may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The above disclosure also encompasses the embodiments listed below:

(1) A method performed by at least one processor in a 5G media streaming uplink (5GMSu) application provider, comprising: establishing a 5GMSu session with a 5GMSu application function (AF) on the 5GMSu application provider; creating a content publishing configuration associated with an uplink media content with the 5GMSu AF, in which the 5GMSu AF provisions a 5GMSu application service (AS) for the content publishing configuration; receiving, from the 5GMSu AF, confirmation that the 5GMSu AS is configured based on the content publishing configuration, the confirmation including an 5GMSu service access information entry; publishing, to a 5GMSu aware application, the 5GMSu service access information entry; and obtaining, from the 5GMSu AS, the uplink media content.

(2) The method according to feature (1), in which the obtaining the uplink media content comprises the 5GMSu application provider pulling the uplink media content from the 5GMSu AS in an egest pull mode.

(3) The method according to feature (2), in which the 5GMSu application provider pulling the uplink media content is triggered by a request from the 5GMSu client through an M8u interface.

(4) The method according to any one of features (1)-(3), in which the obtaining the uplink media content comprises the 5GMSu AS pushing the media content to the 5GMSu application provider in an egest push mode.

(5) The method according to any one of features (1)-(4), in which the 5GMSu AS performs content preparation before making the uplink content ready for being pulled by the 5GMSu application provider or being pushed to the 5GMSu application provider.

(6) The method according to any one of features (1)-(5), in which the content publishing configuration specifies at least one of an egest push mode or an egest pull mode.

(7) The method according to any one of features (1)-(6), in which the 5GMSu AF provisioning the 5GMSu AS comprises: the 5GMSu AF instructing the 5GMSu AS to start one or more content preparation processes, and the 5GMSu AF receiving a response from the 5GMSu AS indicating the content publishing configuration is successful.

(8) The method of any one of features (1)-(7), in which the establishing the 5GMSu session comprises discovering an address of the 5GMSu application function and performing an authentication with the 5GMSu AF.

(9) The method of any one of features (1)-(8), in which the service access information comprises an uplink entry point.

(10) A method performed by at least one processor in a 5G media streaming uplink (5GMSu) application function (AF), comprising: establishing a 5GMSu session on the 5GMSu application provider; creating a content publishing configuration associated with an uplink media content with the 5GMSu application provider; provisioning a 5GMSu application server (AS) for the content publishing configuration; receiving, from the 5GMSu AS, confirmation that the configuration of the 5GMSu AS based on the content publishing configuration is successful; and transmitting, to the 5GMSu application provider, confirmation that the 5GMSu AS is configured based on the content publishing configuration, the confirmation including 5GMSu service access information entry that the 5GMSu application provider publishes to a user equipment (UE).

(11) The method of feature (10), in which the 5GMSu application provider pulls the uplink media content from the 5GMSu AS in an egest pull mode.

(12) The method of feature (11), in which the 5GMSu application provider pulling the uplink media content is triggered by a request from the 5GMSu client through an M8u interface.

(13) The method according to any one of features (10)-(12), in which the 5GMSu AS pushes the media content to the 5GMSu application provider in an egest push mode.

(14) The method according to any one of features (10)-(13), in which the 5GMSu AS performs content preparation before making the uplink content ready for being pulled by the 5GMSu application provider or being pushed to the 5GMSu application provider.

(15) The method according to any one of features (10)-(14), in which the content publishing configuration specifies at least one of an egest push mode or an egest pull mode.

(16) The method according to any one features (10)-(15), in which the provisioning the 5GMSu AS comprises: instructing the 5GMSu AS to start one or more content preparation processes, and receiving a response from the 5GMSu AS indicating the content publishing configuration is successful

(17) The method according to any one of features (10)-(16), in which the service access information entry comprises an uplink entry point.

(18) The method of any one of features (10)-(17), in which the establishing the 5GMSu session comprises the 5GMSu application provider discovering an address of the 5GMSu application function and the 5GMSu application provider performing an authentication with the 5GMSu AF.

(19) A 5G media streaming uplink (5GMSu) application provider server, comprising: at least one memory configured to store program code; and at least one processor configured to read the program code and operate as instructed by the program code, the program code including: establishing code configured to cause the at least one processor to establish a 5GMSu session with a 5GMSu application function (AF) on the 5GMSu application provider; creating code configured to cause the at least one processor to create a content publishing configuration with the 5GMSu AF, in which the 5GMSu AF provisions a 5GMSu application service (AS) for the content publishing configuration; receiving code configured to cause the at least one processor to receive, from the 5GMSu AF, confirmation that a 5GMSu Application Server (AS) is configured based on the content publishing configuration, the confirmation including an 5GMSu service access information entry, publishing code configured to cause the at least one processor to publish, to a 5GMSu aware application, the 5GMSu service access information entry, and obtaining code configured to cause the at least one processor to obtain, from the 5GMSu AS, the uplink media content.

(20) A 5G media streaming uplink (5GMSu) system executing an application function (AF), comprising: at least one memory configured to store program code; and at least one processor configured to read the program code and operate as instructed by the program code, the program code including: establishing code configured to cause the at least one processor to establish a 5GMSu session on the 5GMSu application provider; creating code configured to cause the at least one processor to create a content publishing configuration associated with an uplink media content with the 5GMSu application provider, provisioning code configured to cause the at least one processor to provision a 5GMSu application server (AS) for the content publishing configuration, receiving code configured to cause the at least one processor to receive, from the 5GMSu AS, confirmation that the configuration of the 5GMSu AS based on the content publishing configuration is successful, and transmitting code configured to cause the at least one processor to transmit, to the 5GMSu application provider, confirmation that the 5GMSu AS is configured based on the content publishing configuration, the confirmation including 5GMSu service access information entry that the 5GMSu application provider publishes to a user equipment (UE).

What is claimed is:

1. A method performed by at least one processor in a 5G media streaming uplink (5GMSu) application provider, comprising:
establishing a 5GMSu session with a 5GMSu application function (AF) on the 5GMSu application provider;
creating a content publishing configuration associated with an uplink media content with the 5GMSu AF, wherein the 5GMSu AF provisions a 5GMSu application service (AS) for the content publishing configuration;
receiving, from the 5GMSu AF, confirmation that the 5GMSu AS is configured based on the content publishing configuration, the confirmation including an 5GMSu service access information entry;
publishing, to a 5GMSu aware application, the 5GMSu service access information entry; and
obtaining, from the 5GMSu AS, the uplink media content.

2. The method according to claim 1, wherein the obtaining the uplink media content comprises the 5GMSu application provider pulling the uplink media content from the 5GMSu AS in an egest pull mode.

3. The method according to claim 2, wherein the 5GMSu application provider pulling the uplink media content is triggered by a request from the 5GMSu client through an M8u interface.

4. The method according to claim 1, wherein the obtaining the uplink media content comprises the 5GMSu AS pushing the media content to the 5GMSu application provider in an egest push mode.

5. The method according to claim 1, wherein the 5GMSu AS performs content preparation before making the uplink content ready for being pulled by the 5GMSu application provider or being pushed to the 5GMSu application provider.

6. The method according to claim 1, wherein the content publishing configuration specifies at least one of an egest push mode or an egest pull mode.

7. The method according to claim 1, wherein the 5GMSu AF provisioning the 5GMSu AS comprises: the 5GMSu AF instructing the 5GMSu AS to start one or more content preparation processes, and the 5GMSu AF receiving a response from the 5GMSu AS indicating the content publishing configuration is successful.

8. The method of claim 1, wherein the establishing the 5GMSu session comprises discovering an address of the 5GMSu application function and performing an authentication with the 5GMSu AF.

9. The method of claim 1, wherein the service access information comprises an uplink entry point.

10. A method performed by at least one processor in a 5G media streaming uplink (5GMSu) application function (AF), comprising:
establishing a 5GMSu session on the 5GMSu application provider;
creating a content publishing configuration associated with an uplink media content with the 5GMSu application provider;
provisioning a 5GMSu application server (AS) for the content publishing configuration;
receiving, from the 5GMSu AS, confirmation that the configuration of the 5GMSu AS based on the content publishing configuration is successful; and
transmitting, to the 5GMSu application provider, confirmation that the 5GMSu AS is configured based on the content publishing configuration, the confirmation including 5GMSu service access information entry that the 5GMSu application provider publishes to a user equipment (UE).

11. The method of claim 10, wherein the 5GMSu application provider pulls the uplink media content from the 5GMSu AS in an egest pull mode.

12. The method of claim 11, wherein the 5GMSu application provider pulling the uplink media content is triggered by a request from the 5GMSu client through an M8u interface.

13. The method according to claim 10, wherein the 5GMSu AS pushes the media content to the 5GMSu application provider in an egest push mode.

14. The method according to claim 10, wherein the 5GMSu AS performs content preparation before making the uplink content ready for being pulled by the 5GMSu application provider or being pushed to the 5GMSu application provider.

15. The method according to claim 10, wherein the content publishing configuration specifies at least one of an egest push mode or an egest pull mode.

16. The method according to claim 10, wherein the provisioning the 5GMSu AS comprises: instructing the 5GMSu AS to start one or more content preparation processes, and receiving a response from the 5GMSu AS indicating the content publishing configuration is successful

17. The method according to claim 10, wherein the service access information entry comprises an uplink entry point.

18. The method of claim 10, wherein the establishing the 5GMSu session comprises the 5GMSu application provider discovering an address of the 5GMSu application function and the 5GMSu application provider performing an authentication with the 5GMSu AF.

19. A 5G media streaming uplink (5GMSu) application provider server, comprising:
at least one memory configured to store program code; and
at least one processor configured to read the program code and operate as instructed by the program code, the program code including:
establishing code configured to cause the at least one processor to establish a 5GMSu session with a 5GMSu application function (AF) on the 5GMSu application provider;
creating code configured to cause the at least one processor to create a content publishing configuration with the 5GMSu AF, wherein the 5GMSu AF provisions a 5GMSu application service (AS) for the content publishing configuration;
receiving code configured to cause the at least one processor to receive, from the 5GMSu AF, confirmation that a 5GMSu Application Server (AS) is configured based on the content publishing configuration, the confirmation including an 5GMSu service access information entry,
publishing code configured to cause the at least one processor to publish, to a 5GMSu aware application, the 5GMSu service access information entry, and
obtaining code configured to cause the at least one processor to obtain, from the 5GMSu AS, the uplink media content.

20. A 5G media streaming uplink (5GMSu) system executing an application function (AF), comprising:
at least one memory configured to store program code; and
at least one processor configured to read the program code and operate as instructed by the program code, the program code including:
establishing code configured to cause the at least one processor to establish a 5GMSu session on the 5GMSu application provider;
creating code configured to cause the at least one processor to create a content publishing configuration associated with an uplink media content with the 5GMSu application provider,
provisioning code configured to cause the at least one processor to provision a 5GMSu application server (AS) for the content publishing configuration,
receiving code configured to cause the at least one processor to receive, from the 5GMSu AS, confirmation that the configuration of the 5GMSu AS based on the content publishing configuration is successful, and
transmitting code configured to cause the at least one processor to transmit, to the 5GMSu application provider, confirmation that the 5GMSu AS is configured based on the content publishing configuration, the confirmation including 5GMSu service access information entry that the 5GMSu application provider publishes to a user equipment (UE).
